(19) United States
(12) Patent Application Publication
(10) Pub. No.: US 2005/0173002 A1
(43) Pub. Date: Aug. 11, 2005

(54) Fiber-reinforced polymer (FRP) valve body with a polymeric liner and method of manufacturing same

(76) Inventor: William H. Simendinger, Akron, OH (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 10/981,995

(22) Filed: Nov. 5, 2004

Related U.S. Application Data
(60) Provisional application No. 60/517,595, filed on Nov. 5, 2003.

(51) Int. Cl. F16K 3/22

(52) U.S. Cl. 137/375

(57) ABSTRACT

A lined ball valve includes a preformed polymeric liner having a flow passage therethrough. The flow passage has a valve stem opening transverse to the flow direction. A ball element with a flow opening therethrough is rotatably mounted in the flow passage. A valve stem is connected to the ball element. A body of fiber-reinforced polymer is molded around the preformed liner. A method for manufacturing a lined valve includes the steps of: (a) injection molding a polymeric preformed liner; (b) supporting the preformed polymeric liner inside a body mold; and (c) compression molding a fiber reinforced resin valve body around the preformed liner.

### CROSS REFERENCE TO RELATED APPLICATION

The present application claims benefit from U.S. provisional pat. application Ser. No. 60/517,595, filed Nov. 5, 2003, the disclosure of which is incorporated herein by reference.

### TECHNICAL FIELD OF THE INVENTION

The present invention relates to valves and in particular to a valve with a fiber-reinforced polymer (“FRP”) valve body with a polymeric lining for corrosion protection.

### BACKGROUND

Teflon® and other fluoropolymer linings are used extensively in industry to provide corrosion protection to components of piping and storage systems where corrosive chemicals are handled. These lined components typically include piping, tanks, pumps, metering devices, shutoff valves and control valves. The function of the lining material is to provide a corrosion barrier to protect the structural elements of the component, such as the pump casing, valve body or the pipe wall. The structural element is usually metallic, with carbon steel or ductile iron being the most popular. In the case of pipes and tanks, the fluoropolymer lining may be supported by a filament-wound FRP composite outer shell that is wound around the liner and cured. Filament winding of lined pipes and tanks is feasible because of their uniform cylindrical shape.

Valves, on the other hand, typically have complex internal and external geometries and do not easily lend themselves to filament winding. For this reason, lined valves with integral liners have until now been manufactured by injecting a molten fluoropolymer lining into a metal-bodied valve body. The valve body acts as the mold for the process. This method requires that the body material, since it is in contact with the melted polymer, be able to withstand the heat and pressure of the injection process. Most metals, including common ductile iron and carbon steel, can be used. The metal body can be used as a mold because the metal body can withstand the molding temperature of 650° F. and high pressure developed in the transfer molding process. U.S. Pat. Nos. 3,334,650; 4,696,323; 4,535,803; 5,979,491; 5,634,486; and 3,073,336 disclose prior art valves with corrosion resistant linings.

It has long been demonstrated that advanced polymer composite materials provide corrosion resistance, strength and low cost. The utility of a polymer composite bodied valve could be measurably enhanced if the composite valve body could be fitted with a polymeric liner. With the liner in place, the valve could be used in a wide range of chemical services/applications where normally the flowing fluid would attack the polymer body. Additionally, since the polymer body would be isolated from contact with a high temperature flowing chemical medium, the valve could be used at significantly higher flowing fluid temperatures than valves with composite bodies without the lining. The polymer body provides external corrosion protection from the operating environment that is far superior to the paint used externally on lined valves with metal bodies. A further important advantage is that the weight of a lined composite valve will be far less than the comparable lined valve with a metal body. This reduces the need for costly supporting structures in the piping system. Additionally, a composite valve body has fewer joints, eliminating potential points for leakage.

### SUMMARY OF THE INVENTION

A lined ball valve includes a preformed polymeric liner having a flow passage therethrough. The flow passage has a valve stem opening transverse to the flow direction. A ball element with a flow opening therethrough is rotatably mounted in the flow passage. A valve stem is connected to the ball element. A body of fiber-reinforced polymer is molded around the preformed liner.

The polymeric liner may be preformed from a material chosen from the group of fluoropolymers, PVC and CPVC. The body may be formed from thermoset resin and fiberglass and may be compression molded at a temperature of less than about 300 degrees F.

The valve may include a retainer adapted to retain the preformed liner in the body, wherein the retainer is removably disposed in the valve body and contacts the liner.

The retainer may comprise a tubular member with external threads that threadedly engage internal threads disposed in the valve body. The valve may further include a circumferential shelf disposed in the valve stem opening wherein the shelf is adapted to retain the valve stem.

A method for manufacturing a lined valve includes the steps of: (a) injection molding a polymeric preformed liner; (b) supporting the preformed polymeric liner inside a body mold; and (c) compression molding a fiber reinforced resin valve body around the preformed liner. The method of manufacture may further include after step (a), a step of etching the exterior surface of the preformed liner to increase adhesion of the fiber reinforced body to the liner. The step of etching may be mechanical and/or chemical. The manufacturing process may also include the step of molding mechanical locking ridges on the exterior of the polymeric preformed liner.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a cross-section of a FRP valve with polymeric liner, in accordance with the present invention;

FIG. 2 is an exploded cross-section of the FRP valve of FIG. 1;

FIG. 3 is a cross-section of the polymeric liner of the FRP valve of FIG. 1;

FIG. 4 is a simplified perspective of a FRP valve of the present invention;

FIGS. 5A and 5B are an enlarged cross-section of the valve stem sealing elements of the FRP valve of the present invention; and

FIG. 6 is a simplified partial cross-section of a compression molding press with the polymeric liner of the FRP valve of FIG. 1 disposed therein.

### DESCRIPTION OF THE PREFERRED EMBODIMENTS

Reference is now made to drawings wherein like reference characters denote like or similar parts throughout the Figures.

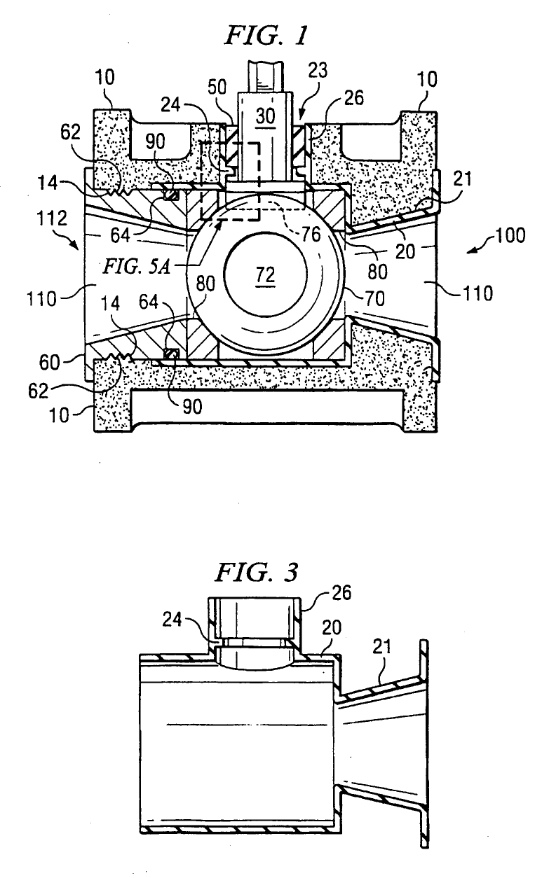

Referring now to FIG. 1, the FRP body 10 of the valve 100 is fully lined with a corrosion resistant liner 20 of polymeric material such as Teflon® or other less costly polymeric material such as PVC or CPVC. It will be understood by those skilled in the art that any polymeric material capable of injection molding may be used in the present invention. The body 10 of valve 100 is molded in one piece from a composite resin. This one piece body eliminates lateral or longitudinal seams used in assembling some prior art valves, thereby eliminating additional sources of leaks.

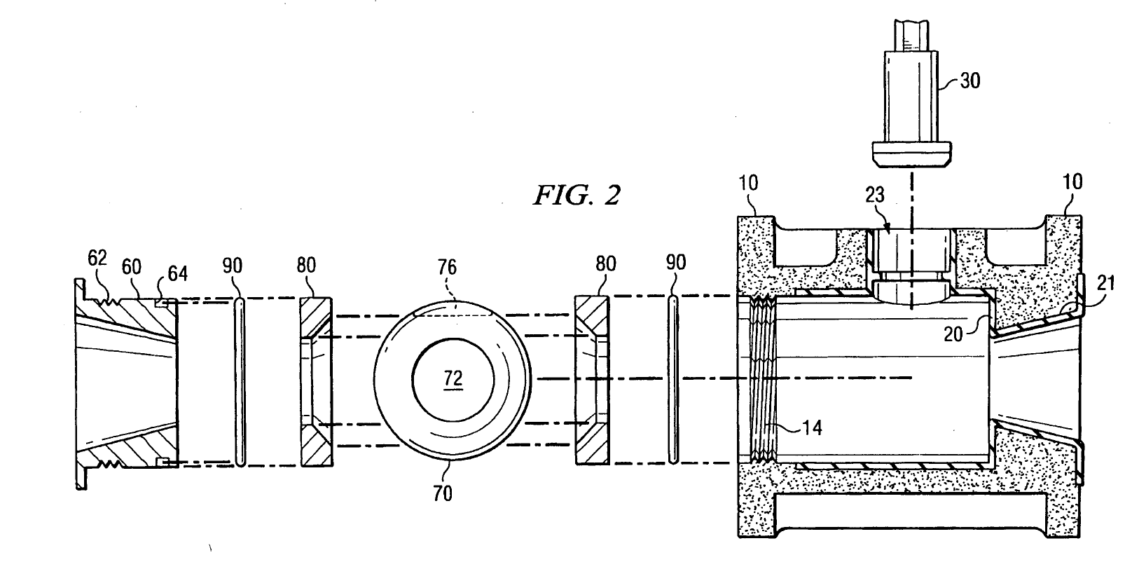

As can be seen in FIGS. 1 and 2, valve 100 is illustrated in a first embodiment as a conventional ball valve. Various types of valves are available to be used across a wide range of applications, such as chemical processing, water control, petroleum refining, and fluid transport. Ball valves are a very popular choice for many of these applications because ball valves are reliable and simple to use. A ball valve 100 in its simplest form comprises a housing or body 10 having flow passage 110 in each end of the body that can be placed in line with, and attached to, a pipe using flanged connections or other means of conventional connections known by one skilled in the art.

A ball element 70, having a cylindrical flow opening 72 through the ball is disposed in the valve body 10. The ball element 70 can be rotated inside the body 10 so that fluid flows when the opening 72 in the ball element 70 is in line with the passage 110 in the valve body and with a pipe containing fluid or gas. Fluid or gas does not flow through valve 100 when the opening 72 through the ball is transverse to the axis of passage 110 in the valve body and the pipe (i.e., when the pipe “sees” only the solid sides of the ball). In this manner, ball valve 100 can be turned from completely closed to wide open simply by turning the ball one-quarter turn.

Flow passage 110 will generally be enlarged slightly at the location of ball element 70 so that ball element 70 can form a seal around the periphery of the flow passage. Seats 80 may be provided in the flow passage 110 and in contact with ball element 70, to prevent fluid leakage when the valve 100 is closed. The depicted embodiment of the valve includes seats 80 on both sides of the ball element 70. This type of valve may be referred to as bi-directional and will seal against fluid flow in either direction. It will be understood by those skilled in the art that the present invention may encompass a unidirection valve having a seat and sealing element disposed only one side of a ball element.

Ball element 70 may be formed from stainless steel or other alloy and encapsulated with a corrosion resistant coating. Alternatively, one skilled in the art will appreciate the ball 70 may be formed of polymeric corrosion resistant material of a predetermined strength based on the intended pressure service for the valve 100. The seals and seats may be formed of any appropriate material, including MN-7 polymer, Teflon, or PTFE or metal, all of which may be encapsulated with corrosion resistant material.

The ball element 70 is rotated and driven by valve stem 30. Valve stem 30 contacts ball element 70 and extends through valve stem opening 23 to the outside of the valve body 10. A packing material or other sealing material 50 may be provided between the valve stem 30 and the valve body 10 to prevent fluid from leaking out of the valve 100. A recess 76 in the ball element may receive an end of the valve stem 30 to provide the connection between the valve stem and ball element. Other alternative means of connection between the ball element and valve stem are well known in the art. The valve stem 30 may be operated manually with a wrench or pre-attached handle or by an actuator, which may be mechanical, electromechanical, pneumatic, or any other suitable form. Manual and/or computer generated signals may provide instructions to the actuator.

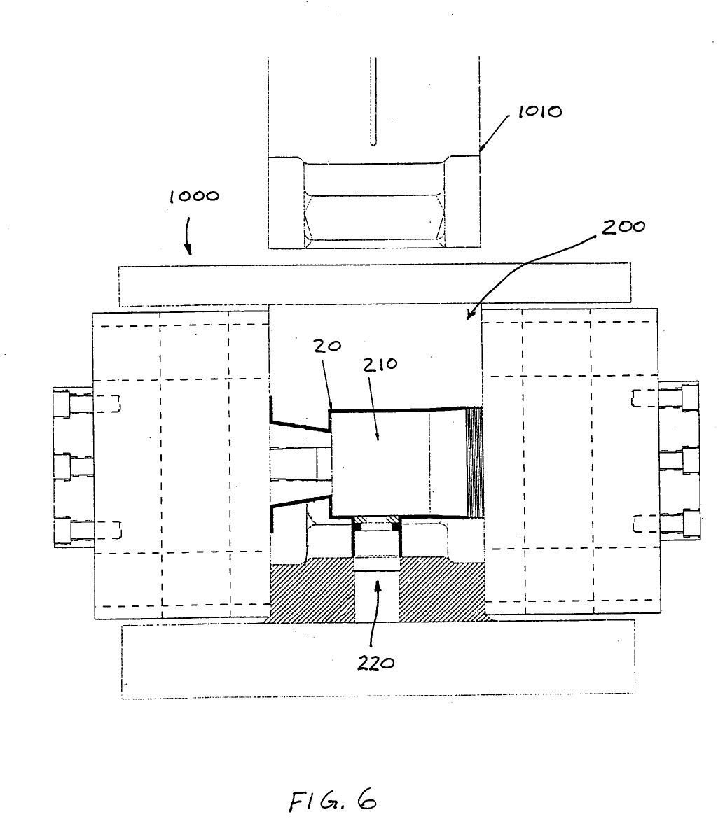

Referring now to FIGS. 2 and 6, therein is illustrated an exploded cross-sectional view of valve 100 and a simplified partial cross-section of a compression molding press 1000. In order to manufacture valve 100, a method must be used to install the liner without using the valve body 10 as a mold, since the polymer valve body 10 cannot survive the combination of high heat of the molten fluoropolymer and pressure during an injection molding process. This dilemma is resolved by reversing the traditional sequence of operations so that a thermoset resin is molded around a preformed fluoropolymer liner 20. The resin is molded to form body 10 utilizing standard compression-molding technology with a press 1000 using punch 1010. During molding of body 10, the liner 20 is supported in a valve body mold 200 using a modification of a normal core pin arrangement of an unlined valve. The polymeric liner 20 may be placed over the waterway core pin 210 of the mold and the preformed liner 20 is oriented to engage the core pin 220 that forms the stem bore 26. The temperature of this molding process, generally less than 300 F., is easily withstood by the preformed liner 20. The preformed liner 20 can be easily and economically produced using a standard injection molding process and can be adapted to provide linings of many different polymeric materials of various costs and service capabilities.

The outer surface 21 of the preformed lining in contact with the resin body material must be prepared with either an etching process or with mechanical locking ridges so that the resin at body 10 will adhere to it. Properly prepared, the liner 20 will not pull away or separate from the FRP body 10 in service.

During manufacture of the valve 100, as heretofore discussed, FRP composite body 10 is formed around the preformed liner 20. An example of one such preformed liner 20 is illustrated in FIG. 3, while FIG. 4 illustrates a simplified version of composite body 10 disposed around liner 20.

Returning to FIGS. 1 and 2, during assembly of the valve 100, after the body 10 has been formed around the liner 20, a first sealing element, comprising an O-ring seal 90 and a seat 80, is inserted from the proximal end 112 of valve 100. It will be understood by those skilled in the art that O-ring seal 90 and seat 80 may be separate elements and one or both may be present. However, it will be understood that a single composite element comprised of an O-ring and seat may be present as a composite sealing element. As used in this specification the component “sealing element” may include any device to prevent the passage of gas and/or fluid.

Ball element 70 is inserted after the first sealing element and then a second sealing element may be inserted. As noted above in the present embodiment the sealing element may include one or both or a composite of an O-ring 90 and seat 80. The ball element 70 and ball sealing elements are secured in position by a tubular shaped retainer 60 having an external threaded portion 62 with external threads that threadedly engage internal threads 14 disposed on an inner surface of valve body 10 in the proximal portion of flow passage 110. As can be seen in FIG. 1, proximal O-ring 90, instead of contacting seat 80 (as shown in FIG. 2) may alternatively be disposed in a recess 64 of retainer 60.

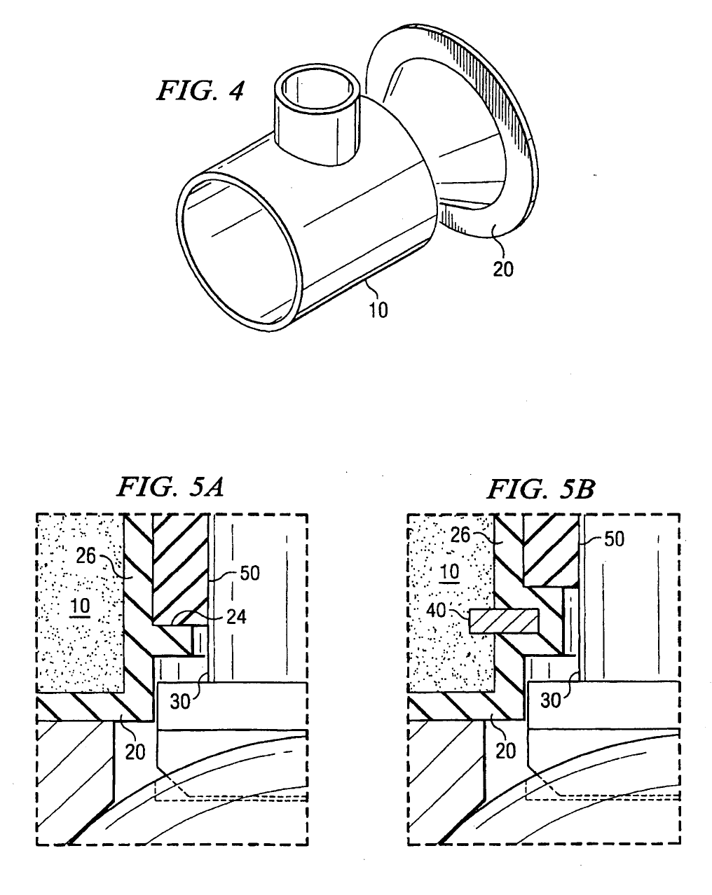

Referring to FIG. 5A, the stem area of the ball valve presents a challenge inasmuch as the stem 30 must penetrate the body 10 but must also be prevented from blowing out of the body in the event that an operator inadvertently removes the packing gland bolts (not shown) with the valve still under pressure. In the current invention, this feature can be provided by introducing a circumferential shelf 24 in the valve stem opening 23 of liner 20. Alternatively, as illustrated in FIG. 5B, a rigid ring 40 may be disposed around the neck 26 of preformed liner 20 prior to compression molding of the body 10 around liner 20 and ring 40.

It will be understood by those skilled in the art that check valves, diaphragm valves, plug valves and butterfly valves may be manufactured using the processes disclosed in the present invention.

A preferred embodiment of the invention has been illustrated in the accompanying drawings and described herein. It will be understood that the invention is not limited to the embodiments disclosed, but is capable of numerous modifications without departing from the principles of the present invention, which is intended to be limited only by the scope of the appended claims, as interpreted according to the principles of patent law.

1. A lined ball valve comprising:
a preformed polymeric liner having a flow passage therethrough, said flow passage having a proximal portion, a distal portion and a middle portion, said middle portion having a valve stem opening transverse to the flow direction;
a body of fiber-reinforced polymer molded around said preformed liner;
a ball element rotatably mounted in said flow passage, said ball element including a flow opening therethrough; and
a valve stem connected to said ball element, said valve stem adapted to rotate said ball element to control the flow through said flow passage, said valve stem disposed in said valve stem opening.

2. The ball valve of claim 1, wherein said polymeric liner is preformed from a material chosen from the group of fluoropolymers.

3. The ball valve of claim 1, wherein said polymeric liner is preformed from a material chosen from the group of PVC and CPVC.

4. The ball valve of claim 1, wherein said body is formed from thermoset resin and fiberglass.

5. The ball valve of claim 4, wherein the thermoset resin may be compression molded at a temperature of less than 300 degrees F.

6. The ball valve of claim 1 further including a sealing element disposed in said flow passage and contacting said ball element.

7. The ball valve of claim 1 further including a retainer adapted to retain said preformed liner in the body, said retainer removably disposed in said valve body and contacting said liner.

8. The ball valve of claim 1 further including a retainer comprising a tubular member with external threads that threadedly engage internal threads disposed in said valve body.

9. The ball valve of claim 1 further including a circumferential shelf disposed in said valve stem opening, said shelf adapted to retain said valve stem.

10. A method for manufacturing a lined valve comprising the steps of:
(a) injection molding a polymeric preformed liner;
(b) supporting said preformed polymeric liner inside a body mold; and
(c) subsequent to steps (a) and (b), compression molding a fiber reinforced resin valve body around said preformed liner.

11. The method of claim 10 further including after step (a) and before step (c), a step of etching the exterior surface of said preformed liner to increase adhesion of said fiber reinforced body to said liner.

12. The method of claim 11, wherein the step of etching is mechanical.

13. The method of claim 11, wherein the step of etching includes chemical etching.

14. The method of claim 10, wherein the step of molding a polymeric preformed liner includes molding mechanical locking ridges on the exterior of a polymeric preformed liner.

15. The method of claim 10, wherein the step of molding is conducted at a temperature of 300 degrees F. or less.
